(19) United States
(12) Patent Application Publication
(10) Pub. No.: US 2008/0162633 A1
(43) Pub. Date: Jul. 3, 2008

(54) AUTOMATED INSTANT MESSAGING CHAT SUSPENSION AND RESUMPTION

(76) Inventors: Josef Scherpa, Fort Collins, CO (US); Edward E. Ahigian, Jamaica Plain, MA (US); Andrew L. Schirmer, Andover, MA (US); Christine L. Samoiloff, Princeton, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/616,559

(22) Filed: Dec. 27, 2006

(51) Int. Cl. G06F 15/16

(52) U.S. Cl. 709/204

(57) ABSTRACT

Embodiments of the present invention address deficiencies of the art in respect to instant messaging and provide a method, system and computer program product for. In one embodiment of the invention, a chat session suspension and resumption management method can include establishing a chat session among at least two conversants, receiving a request by one of the conversants to suspend the established chat session for a specified duration of time, and suspending the chat session for the specified duration of time and automatically resuming the chat session subsequent to the specified duration of time without further instruction by the conversants. The method further can include determining whether the request to suspend the established chat session for the specified duration of time permits negotiation of the specified duration of time, and exchanging negotiated durations of time between the conversants until arriving at an agreed upon duration only if permitted by the request.

### BACKGROUND OF THE INVENTION

1. Field of the Invention

The present invention relates to the field of instant messaging and more particularly instant messaging chat session interruption management.

2. Description of the Related Art

Electronic mail, referred to in the art as e-mail, has proven to be the most widely used computing application globally. Though e-mail has been a commercial staple for several decades, due to the explosive popularity and global connectivity of the Internet, e-mail has become the preferred mode of asynchronous communications, regardless of the geographic separation of communicating parties. Today, more e-mails are processed in a single hour than phone calls. Clearly, e-mail as an asynchronous mode of communications has been postured to replace all other modes of communications excepting voice telephony.

In contrast to the asynchronous nature of e-mail, the recent rapid development of the Internet has led to advanced modes of synchronous, real-time collaboration able to fulfill the real-time communicative requirements of the modern computing participant. Using the Internet as a backbone, individuals worldwide can converge in real-time in cyberspace to share ideas, documents and images in a manner not previously possible through conventional telephony and video conferencing. To facilitate collaboration over the Internet, a substantial collection of synchronous messaging technologies and protocols have been assembled to effectively deliver audio, video and data over the single data communications medium of the Internet. These synchronous messaging technologies include several, real-time human-to-human collaborative environments such as instant messaging and persistent chat rooms.

In the conventional instant messaging and chat environment, different collaborators can engage in a real-time exchange of messages including text messages, graphical information and even audiovisual information in a common messaging space. The common messaging space can accommodate a pair of conversants to a chat, or multiple conversants to a conference. In some circumstances, the initiation of the chat can be spontaneous upon one conversant recognizing the presence and availability of a partner conversant. In other circumstances, the initiation of the chat can be planned and can even subsist in a calendared event in a calendaring and scheduling system.

When initiating a chat session, whether spontaneously or as planned, choosing the duration for the chat can be an imprecise exercise. Knowing how much time will be required to effectively exchange ideas in the common space can be difficult at best. Additionally, interruptions to a chat can be common including ringing telephones, inbound e-mails and even additional chat session invitations. Consequently, chat sessions often can be interrupted requiring the conversants to schedule a new time for initiating a continuation to the chat session. In all too many circumstances, a partner conversant can be invited by the interrupted conversant only to try to re-establish a chat session at a later date without any specific reference to a time slot.

### BRIEF SUMMARY OF THE INVENTION

Embodiments of the present invention address deficiencies of the art in respect to instant messaging and provide a method, system and computer program product for. In one embodiment of the invention, a chat session suspension and resumption management method can include establishing a chat session among at least two conversants, receiving a request by one of the conversants to suspend the established chat session for a specified duration of time, and suspending the chat session for the specified duration of time and automatically resuming the chat session subsequent to the specified duration of time without further instruction by the conversants. The method further can include determining whether the request to suspend the established chat session for the specified duration of time permits negotiation of the specified duration of time, and exchanging negotiated durations of time between the conversants until arriving at an agreed upon duration only if permitted by the request.

In one aspect of the embodiment, receiving a request by one of the conversants to suspend the established chat session for a specified duration of time can include receiving a request by one of the conversants to suspend the established chat session for a specified duration of time defined by a time to resume the established chat session. In this regard, the method also can include providing a free/busy time view before specifying a duration of time defined by a time to resume the established chat session. In another aspect of the embodiment, the method further can include inserting a transcript from the established chat session into the resumed chat session.

In another embodiment of the invention, an instant messaging data processing system can be configured for chat session suspension and resumption. The system can include an instant messaging server configured for coupling to different instant messaging clients over a computer communications network. The system also can include chat suspension/resumption logic coupled to the instant messaging server. The chat suspension/resumption logic can include program code enabled to receive a request by a conversant to a chat session to suspend the chat session for a specified duration of time and to suspend the chat session for the specified duration of time before automatically resuming the chat session subsequent to the specified duration of time without further instruction by the conversant.

The system also can include chat suspension/negotiation logic coupled to at least one of the instant messaging clients. The chat suspension/negotiation logic can include program code enabled to render an instant messenger user interface. The user interface can include a transcript view, a text entry view and a suspension view. The instant messenger user interface further can include a resumption view. Finally, the suspension view can include a link to a free/busy time view.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A through 1D, taken together, are an exemplary screen shot progression illustrating a process for managing the suspension and resumption of a chat session;

FIG. 2 is a schematic illustration of a instant messaging data processing system configured for the managed suspension and resumption of a chat session; and,

FIG. 3 is a flow chart illustrating a process for the managed suspension and resumption of a chat session.

### DETAILED DESCRIPTION OF THE INVENTION

Embodiments of the present invention provide a method, system and computer program product for the managed suspension and resumption of a chat session. In accordance with an embodiment of the present invention, a chat session in process can be interrupted by one conversant to the chat session with a request to suspend the chat session, but to resume the chat session at a later time. The time can be specified unopposed by one conversant to the chat session, or the time can be negotiated. Thereafter, the chat session can be automatically resumed at the designated time between the original conversants to the chat session without requiring the manual intervention of the original conversants to establish the resumed chat session.

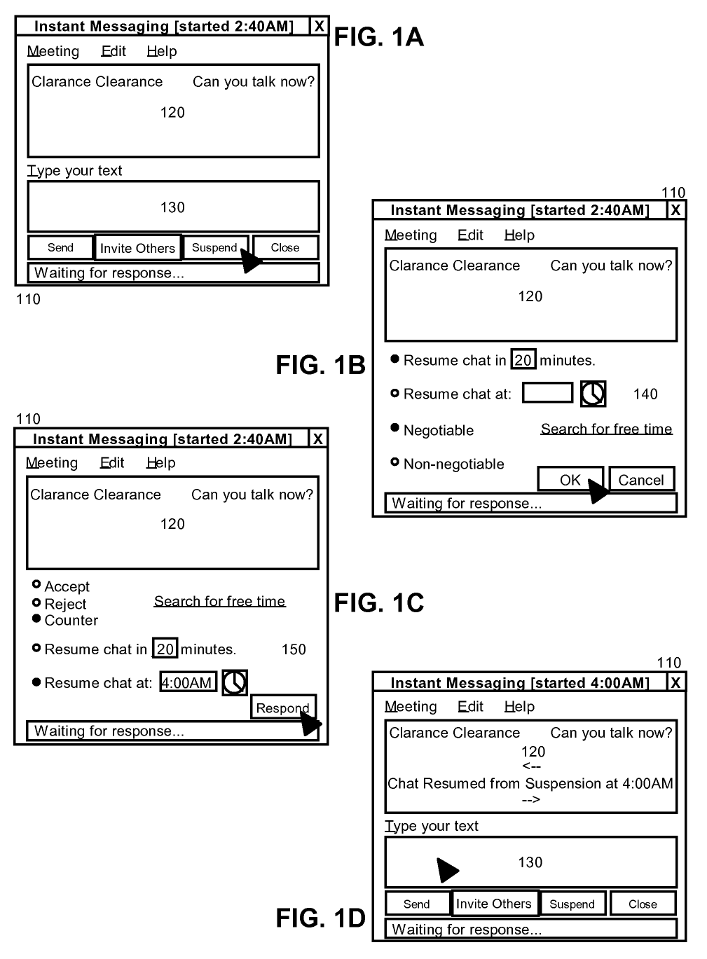

In further illustration, FIGS. 1A through 1D, taken together, are an exemplary screen shot progression illustrating a process for managing the suspension and resumption of a chat session. Considering first FIG. 1A, an instant messenger 110 is shown. The instant messenger 110 can be configured to permit an end user to establish a chat session with one or more conversants. Once a chat session has been established, the instant messenger 110 can provide a transcript view 120 of the established chat session and a text entry view 130 into which an instant message can be provided for posting to the chat session in the transcript view 120.

Notably, the instant messenger 110 can be configured, in the course of an established chat session, to propose the suspension of the established chat session at the behest of a conversant to the established chat session. As shown in FIG. 1B, once the suspension of the established chat session has been proposed, a designated time for resuming the chat session can be provided in a resumption view 140 in the instant messenger 110. The designated time can be specified in terms of a duration of the suspension, or a particular time at which the chat session is to resume. To facilitate the latter, a link to a free/busy time view can be provided through the instant messenger.

Importantly, the designated time further can be characterized by the conversant to the established chat session proposing the suspension as either negotiable or non-negotiable. In the non-negotiable context, the other conversants to the established chat session can accept or reject the proposed suspension. In the negotiable context, however, the other conversants can provide alternative suggestions for a designated time to resume the established chat session. Specifically, as shown in FIG. 1C, the instant messenger 110 can provide a negotiation view 150. The negotiation view can provide controls for either accepting or rejecting the designated time for resuming the chat session, or for counter-proposing a different designated time.

Finally, once the designated time has been proposed and accepted by all conversants to the established chat session, the chat session can be suspended until the designated time. Upon the designated time, a new chat session can be established with the different conversants from the suspended chat session in an automated fashion without requiring the manual intervention of any one of the conversants in requesting the re-establishment of the chat session as shown in FIG. 1D. Optionally, the transcript from the suspended chat session can be inserted into the transcript of the new chat session to provide an appearance of continuity despite the suspension.

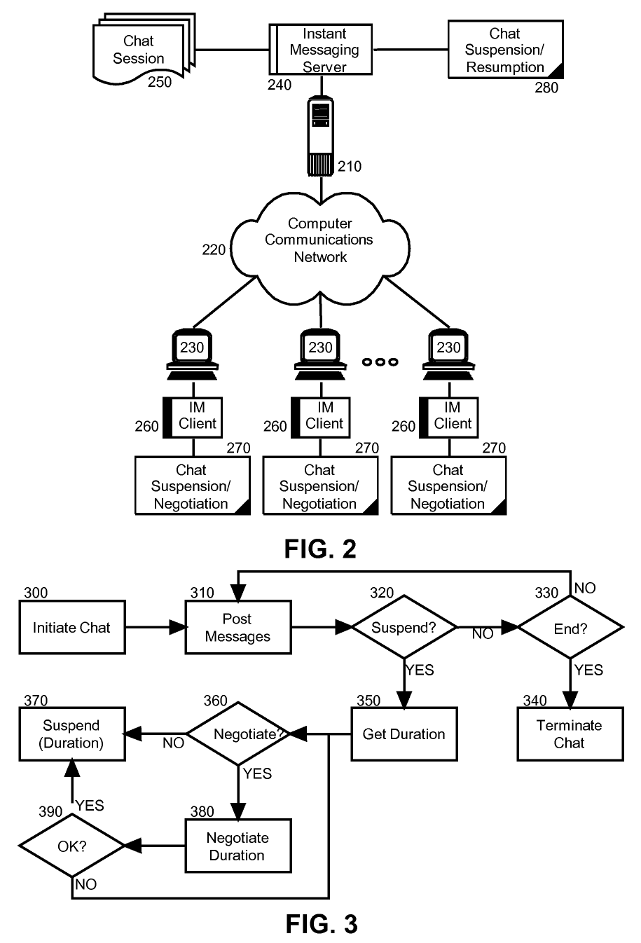

In yet further illustration, FIG. 2 is a schematic illustration of a instant messaging data processing system configured for the managed suspension and resumption of a chat session. The system can include a host computing platform 210 coupled to one or more client computing platforms 230 over a computer communications network 220. The host computing platform 210 can support the operation of an instant messaging server 240 which in turn can support the establishment and maintenance of multiple, different chat sessions 250 with different instant messaging clients 260 disposed in corresponding ones of the client computing platforms 230.

Notably, chat suspension/negotiation logic 270 can be coupled to the instant messaging clients 260 and chat suspension/resumption logic 280 can be coupled to the instant messaging server 240. The chat suspension/negotiation logic 270 can include program code enabled to provide a user interface for initiating the suspension of an established one of the chat sessions 250. The program code of the chat suspension/negotiation logic 270 also can be enabled to specify a designated time for resuming the suspended one of the chat sessions 250. Finally, the program code of the chat suspension/negotiation logic 270 can be enabled to facilitate the negotiation of a proposed designated time for resuming the suspended one of the chat sessions 250.

The chat suspension/resumption logic 280, by comparison, can include program code enabled to receive suspension requests from different ones of the instant messaging clients 260 in respect to corresponding established ones of the chat sessions 250. The program code further can be enabled to moderate the negotiation of a resumption time amongst conversants to each of the established ones of the chat sessions 250 selected for suspension. Finally, the program code can be enabled to automatically re-establish new ones of the chat sessions 250 between the conversants of the suspended ones of the chat sessions 250 without requiring the manual initiation of the resumed ones of the chat sessions 250 by the conversants.

In illustration of the operation of the chat suspension/resumption logic 280, FIG. 3 is a flow chart illustrating a process for the managed suspension and resumption of a chat session. The process can begin in block 300 with the initiation and establishment of a chat session. In block 310 one or more messages can be exchanged through the established chat session among the conversants to the established chat session. In decision block 320, it can be determined whether any of the conversants to the chat session has elected to suspend the established chat session. If so the process can continue through block 350. If not, in decision block 330 it further can be determined whether or not to terminate the chat session. If not, additional messages can be exchanged in block 310. Otherwise, the chat session can be terminated in block 340.

In decision block 320, if it is determined that a conversant to the chat session has elected to suspend the established chat session, in block 350 a duration of the suspension can be received from the requesting conversant and provided to the remaining conversants to the established chat session. In decision block 360, it can be determined whether the requesting conversant has permitted negotiation of the determined duration for the suspension of the established chat session. If not, in block 370 the established chat session can be suspended for the determined duration subsequent to which the chat session can be resumed. Otherwise, in block 380, the duration of the suspension can be negotiated amongst the conversants to the established chat session. If in decision block 390, a duration of time can be agreed upon, again in block 370 the established chat session can be suspended for the agreed upon duration.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A chat session suspension and resumption management method comprising:
establishing a chat session among at least two conversants;
receiving a request by one of the conversants to suspend the established chat session for a specified duration of time; and,
suspending the chat session for the specified duration of time and automatically resuming the chat session subsequent to the specified duration of time without further instruction by the conversants.

2. The method of claim 1, further comprising:
determining whether the request to suspend the established chat session for the specified duration of time permits negotiation of the specified duration of time; and,
exchanging negotiated durations of time between the conversants until arriving at an agreed upon duration only if permitted by the request.

3. The method of claim 1, wherein receiving a request by one of the conversants to suspend the established chat session for a specified duration of time, comprises receiving a request by one of the conversants to suspend the established chat session for a specified duration of time defined by a time to resume the established chat session.

4. The method of claim 3, further comprising providing a free/busy time view before specifying a duration of time defined by a time to resume the established chat session.

5. The method of claim 1, further comprising inserting a transcript from the established chat session into the resumed chat session.

6. An instant messaging data processing system configured for chat session suspension and resumption, the system comprising:
an instant messaging server configured for coupling to a plurality of instant messaging clients over a computer communications network; and,
chat suspension/resumption logic coupled to the instant messaging server, the chat suspension/resumption logic comprising program code enabled to receive a request by a conversant to a chat session to suspend the chat session for a specified duration of time and to suspend the chat session for the specified duration of time before automatically resuming the chat session subsequent to the specified duration of time without further instruction by the conversant.

7. The system of claim 6, further comprising chat suspension/negotiation logic coupled to at least one of the instant messaging clients, the chat suspension/negotiation logic comprising program code enabled to render an instant messenger user interface comprising a transcript view, a text entry view and a suspension view.

8. The system of claim 7, wherein the instant messenger user interface further comprises a resumption view.

9. The system of claim 7, wherein the suspension view comprises a link to a free/busy time view.

10. A computer program product comprising a computer usable medium having computer usable program code for chat session suspension and resumption management, the computer program product including:
computer usable program code for establishing a chat session among at least two conversants;
computer usable program code for receiving a request by one of the conversants to suspend the established chat session for a specified duration of time; and,
computer usable program code for suspending the chat session for the specified duration of time and automatically resuming the chat session subsequent to the specified duration of time without further instruction by the conversants.

11. The computer program product of claim 10, further comprising:
computer usable program code for determining whether the request to suspend the established chat session for the specified duration of time permits negotiation of the specified duration of time; and,
computer usable program code for exchanging negotiated durations of time between the conversants until arriving at an agreed upon duration only if permitted by the request.

12. The computer program product of claim 10, wherein the computer usable program code for receiving a request by one of the conversants to suspend the established chat session for a specified duration of time, comprises computer usable program code for receiving a request by one of the conversants to suspend the established chat session for a specified duration of time defined by a time to resume the established chat session.

13. The computer program product of claim 12, further comprising computer usable program code for providing a free/busy time view before specifying a duration of time defined by a time to resume the established chat session.

14. The computer program product of claim 10, further comprising computer usable program code for inserting a transcript from the established chat session into the resumed chat session.
